(19) United States
(12) Patent Application Publication
(10) Pub. No.: US 2024/0279411 A1
(43) Pub. Date: Aug. 22, 2024

(54) REUSABLE SILICONE WRAPS AND METHODS OF MAKING THE SAME

(71) Applicants: Easy Factory Limted, Quarry Bay (HK); Very Great Inc., New York, NY (US)

(72) Inventors: Jean-Charles VIANCIN, Clear Water Bay (HK); Laurent MEYER, Guangzhou (CN); Eric C. PRUM, New York, NY (US); Joshua K. WILLIAMS, New York, NY (US)

(21) Appl. No.: 18/583,014

(22) Filed: Feb. 21, 2024

Related U.S. Application Data
(60) Provisional application No. 63/486,115, filed on Feb. 21, 2023.

(51) Int. Cl. C08J 5/18; B29C 43/00; B29C 45/00; B29K 83/00

(52) U.S. Cl. CPC C08J 5/18; B29C 43/003; B29C 45/0001; B29C 2945/76585; B29C 2948/92152; B29K 2083/005; C08J 2383/04

(57) ABSTRACT

Reusable silicone wraps for use, alone or in conjunction with another storage container, to form an air-tight seal around a perishable item, such as a foodstuff.

### CROSS REFERENCE TO RELATED APPLICATION

The application claims the benefit of U.S. Provisional Application No. 63/486,115 filed Feb. 21, 2023, the entire contents of which are incorporated by reference herein.

### FIELD OF THE INVENTION

The invention relates to reusable silicone wraps and methods of making the same. More specifically, the invention relates to reusable silicone wraps for use in the storage of perishable items such as foodstuffs.

### BACKGROUND OF THE DISCLOSURE

Various types of food storage containment vehicles are known in the art that allow for foodstuffs to remain edible for longer periods of time as compared to when stored in a way that subjects foodstuffs to the surrounding atmosphere over time. Some food storage containment vehicles, such as glass or plastic containers and lids, are reusable. Glass and plastic container/lid storage means, however, may not be desirable in some instances. For example, the physical dimensions of such storage means and the physical dimensions of the foodstuff to be stored therein may incongruent, leading to a) wasted storage space in the container, which results in a pocket of air in the container that may accelerate foodstuff spoilage over time, and/or b) required use of more than one container/lid storage means to store the foodstuff. Additionally, as glass and plastic container/lid storage means are rigid or substantially rigid in shape, their storage in a storage space such as a cupboard or refrigerator may result in inefficient utilization of the overall dimensions of said storage space. Also, when glass and plastic container/lid storage means are not being used for foodstuff storage, storage of the glass and plastic container/lid storage means themselves may be challenging.

Many alternatives to glass and plastic container/lid storage means exist such as, for example, aluminum foil, rescalable polyethylene bags, paper bags, polyethylene films (for example, sold by S.C. Johnson & Son, Inc as Saran™ wrap), polyvinylidene chloride films, wax paper and parchment paper. While these types of storage means are advantageous over rigid storage containers in some regards, for example their lack of rigid structure that leads smaller and/or more efficiently utilized storage space footprint, they are not without deficiencies. For example aluminum foil, wax paper and parchment paper generally do not create an effective air seal, easily tear, and are not elastically deformable. None of the above are generally recommended for use in a microwave and none are traditionally viewed as reusable. To the extent that the some of the above can be cleaned for reuse, the method of cleaning may be limited to washing by hand. Generally, however, the cleaning and reuse of aluminum foil, resealable polyethylene bags, paper bags, polyethylene films, polyvinylidene chloride films, wax paper and parchment paper is not contemplated by users of such articles.

### SUMMARY OF THE INVENTION

Disclosed herein are reusable silicone wraps and methods of making the same. Reusable silicone wraps according to various aspects of the disclosure can be used to form an air-tight seal, alone or in conjunction with another storage container, around a perishable item, such as a foodstuff.

A first embodiment of the disclosure can be described as a reusable silicone wrap, the wrap having a shore A hardness value ranging from about 20 to about 70 and a thickness ranging from about 0.02 mm to about 1.0 mm.

A second embodiment of the disclosure can be described as a reusable silicone wrap according to the first embodiment, wherein the wrap has a shore A hardness value ranging from about 20 to about 60.

A third embodiment of the disclosure can be described as a reusable silicone wrap according to the first embodiment, wherein the wrap has a shore A hardness value ranging from about 20 to about 50.

A fourth embodiment of the disclosure can be described as a reusable silicone wrap according to the first embodiment, wherein the wrap has a shore A hardness value ranging from about 20 to about 40.

A fifth embodiment of the disclosure can be described as a reusable silicone wrap according to the first embodiment, wherein the wrap has a shore A hardness value ranging from about 30 to about 40.

A sixth embodiment of the disclosure can be described as a reusable silicone wrap according to the first embodiment, wherein the wrap has a shore A hardness value ranging from about 30 to about 50.

A seventh embodiment of the disclosure can be described as a reusable silicone wrap according to any one of the first through sixth embodiments, wherein the wrap has a thickness ranging from about 0.5 mm to about 1.0 mm.

An eighth embodiment of the disclosure can be described as a reusable silicone wrap according to any one of the first through sixth embodiments, wherein the wrap has a thickness ranging from about 0.02 mm to about 0.5 mm.

A ninth embodiment of the disclosure can be described as a reusable silicone wrap according to any one of the first through eighth embodiments, wherein the wrap has lateral dimensions approximating any one of a square, a rectangle, a circle, an oval, a hexagon, and an octagon.

A tenth embodiment of the disclosure can be described as a reusable silicone wrap according to any one of the first through ninth embodiments, wherein the wrap is dimensioned to wrap around a foodstuff to form an air-tight seal around the foodstuff.

An eleventh embodiment of the disclosure can be described as a reusable silicone wrap according to any one of the first through ninth embodiments, wherein the wrap is dimensioned to engage one or more surfaces of a piece of kitchenware to form an air-tight seal between the reusable silicone wrap and the piece of kitchenware.

A twelfth embodiment of the disclosure can be described as a reusable silicone wrap according to the eleventh embodiment, wherein the one or more surfaces of a piece of kitchenware comprises an outer rim, a sidewall, and bottom surface.

A thirteenth embodiment of the disclosure can be described as a reusable silicone wrap according to any one of the first through twelfth embodiments, wherein the wrap is made from a liquid silicone rubber (LSR) composition.

A fourteenth embodiment of the disclosure can be described as a reusable silicone wrap according to the thirteenth embodiment, wherein the LSR composition comprises a liquid silicone rubber and one or more additives.

A fifteenth embodiment of the disclosure can be described as a reusable silicone wrap according to the fourteenth embodiment, wherein the one or more additives are selected from the group consisting of colorants, fillers, antimicrobial agents, biodegradable agents, anti-yellowing agents, and anti-static agents.

A sixteenth embodiment of the disclosure can be described as a reusable silicone wrap according to the fourteenth or fifteenth embodiment, wherein the LSR composition comprises from about 97 wt % to about 99.8 wt % of a liquid silicone rubber and from about 0.2 wt % to about 3.0 wt % of the one or more additives.

A seventeenth embodiment of the disclosure can be described as a reusable silicone wrap according to any one of the fourteenth through sixteenth embodiments, wherein the LSR composition comprises from about 0.2 wt % to about 3.0 wt % of fillers.

An eighteenth embodiment of the disclosure can be described as a reusable silicone wrap according to any one of the fourteenth through sixteenth embodiments, wherein the LSR composition comprises from about 0.2 wt % to about 3.0 wt % of antimicrobial agents.

A nineteenth embodiment of the disclosure can be described as a reusable silicone wrap according to any one of the fourteenth through sixteenth embodiments, wherein the LSR composition comprises from about 0.2 wt % to about 3.0 wt % of biodegradable agents

A twentieth embodiment of the disclosure can be described as a reusable silicone wrap according to any one of the fourteenth through sixteenth embodiments, wherein the LSR composition comprises from about 0.2 wt % to about 3.0 wt % of anti-yellowing agents.

A twenty-first embodiment of the disclosure can be described as a reusable silicone wrap according to any one of the fourteenth through sixteenth embodiments, wherein the LSR composition comprises from about 0.2 wt % to about 3.0 wt % of anti-static agents.

A twenty-first embodiment of the disclosure can be described as a reusable silicone wrap according to any one of the fourteenth through sixteenth embodiments, wherein the LSR composition comprises from about 0.2 wt % to about 3.0 wt % of anti-yellowing agents.

A twenty-second embodiment of the disclosure can be described as a reusable silicone wrap according to any one of the first through twenty-first embodiments, wherein the wrap comprises a foodstuff-facing surface and an environment-facing surface.

A twenty-third embodiment of the disclosure can be described as a reusable silicone wrap according to the twenty-second embodiment, wherein the foodstuff-facing surface is microtextured.

A twenty-fourth embodiment of the disclosure can be described as a reusable silicone wrap according to the twenty-third embodiment, wherein the environment-facing surface is microtextured.

A twenty-fifth embodiment of the disclosure can be described as a reusable silicone wrap according to the twenty-second embodiment, wherein the foodstuff-facing surface is microtextured and the environment-facing surface is microtextured.

A twenty-sixth embodiment of the disclosure can be described as a reusable silicone wrap according to any one of the twenty-second through twenty-fifth embodiments, further comprising an aesthetic layer immobilized on the environment-facing surface.

A twenty-seventh embodiment of the disclosure can be described as a reusable silicone wrap according to the twenty-sixth embodiment, wherein the aesthetic layer comprises a colorant and/or graphics.

A twenty-eighth embodiment of the disclosure can be described as a reusable silicone wrap according to any one of the first through twenty-sixth embodiments, wherein the wrap is produced by any one of an injection molding process, a compression molding process, a calendering process, or a coating process.

A twenty-ninth embodiment of the disclosure can be described as a reusable silicone wrap according to any one of the first through twenty-sixth embodiments, wherein the wrap is produced by an injection molding process.

A thirtieth embodiment of the disclosure can be described as a reusable silicone wrap according to any one of the first through twenty-sixth embodiments, wherein the wrap is produced by a compression molding process.

### BRIEF DESCRIPTION OF THE DRAWINGS

FIGS. 1 and 2 are images of an exemplary reusable silicone wrap in accordance with various aspects of the disclosure;

FIGS. 3 and 4 are images of another exemplary reusable silicone wrap in accordance with various aspects of the disclosure;

FIG. 5 is an image of yet another exemplary reusable silicone wrap in accordance with various aspects of the disclosure;

FIG. 6 is an image of yet another exemplary reusable silicone wrap in accordance with various aspects of the disclosure;

FIG. 7 is an image of the reusable silicone wrap of FIG. 6 in various states of use;

FIG. 8 is an image of the reusable silicone wrap of FIG. 6 in another state of use; and

FIG. 9 is a partial image of an injection mold used to make reusable silicone wraps in accordance with various aspects of the disclosure.

### DETAILED DESCRIPTION

The following description of the embodiments is merely exemplary in nature and is in no way intended to limit the subject matter of the disclosure, their application, or uses.

As used throughout, ranges are used as shorthand for describing each and every value that is within the range. Any value within the range can be selected as the terminus of the range. Unless otherwise specified, all percentages and amounts expressed herein and elsewhere in the specification should be understood to refer to percentages by weight.

For the purposes of this specification and appended claims, unless otherwise indicated, all numbers expressing quantities, percentages or proportions, and other numerical values used in the specification and claims, are to be understood as being modified in all instances by the term “about.” The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent, alternatively ±5 percent, alternatively ±1 percent, alternatively ±0.5 percent, and alternatively ±0.1 percent of the given numeric value provided such a deviation does not alter the end function or result of the value. Accordingly, unless indicated to the contrary, the numerical parameters set forth in this specification and attached claims are approximations that can vary depending upon the desired properties sought to be obtained by the invention.

It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. For example, as used in this specification and the following claims, the terms “comprise” (as well as forms, derivatives, or variations thereof, such as “comprising” and “comprises”), “include” (as well as forms, derivatives, or variations thereof, such as “including” and “includes”) and “has” (as well as forms, derivatives, or variations thereof, such as “having” and “have”) are inclusive (i.e., open-ended) and do not exclude additional elements or steps. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

Reusable silicone wraps in accordance with various aspects of the disclosure can be in any suitable shape. In some instances, reusable silicone wraps in accordance with various aspects of the disclosure can be square in shape. In other instances, reusable silicone wraps in accordance with various aspects of the disclosure can be rectangular in shape. In yet other instances, reusable silicone wraps in accordance with various aspects of the disclosure can be circular in shape. In yet other instances, reusable silicone wraps in accordance with various aspects of the disclosure can be oval in shape. In yet other instances, reusable silicone wraps in accordance with various aspects of the disclosure can be hexagonal in shape. In yet other instances, reusable silicone wraps in accordance with various aspects of the disclosure can be octagonal in shape. These shapes are exemplary in nature and other shapes may be envisioned.

Reusable silicone wraps in accordance with various aspects of the disclosure can have any suitable lateral (i.e., length and width) dimensions. In some instances, reusable silicone wraps in accordance with various aspects of the disclosure can be dimensioned to wrap around an individual foodstuff (such as, for example, a fruit, a vegetable, a tuber, a cooked or raw meat, a baked or sugar confection, and so on) forming an air-tight seal around the foodstuff.

In some instances, reusable silicone wraps in accordance with various aspects of the disclosure can be dimensioned to engage one or more surfaces (such as an outer rim, sidewall(s), bottom surface(s), and so on) of a piece of kitchenware (such as, for example, a pie dish, a baking sheet, a baking dish, a casserole dish, a cup, a bowl, a plate, a gravy boat, and so on, of varying shapes and dimensions) to form an air-tight seal between the reusable silicone wrap and the piece of kitchenware. Reusable silicone wraps in accordance with various aspects of the disclosure form air-tight seals around foodstuffs and air-tight seals with kitchenware by gripping surfaces of the foodstuffs/kitchenware and/or gripping themselves, wherein the gripping is solely due to surface interactions such as friction (i.e., without the aid of adhesives, tackifiers, and so on).

Reusable silicone wraps in accordance with various aspects of the disclosure can have any suitable thickness. In some instances, reusable silicone wraps in accordance with various aspects of the disclosure can have thicknesses ranging from about 0.01 millimeters (mm) to about 3.0 mm. Preferably, reusable silicone wraps in accordance with various aspects of the disclosure have thicknesses ranging from about 0.02 mm to about 2.0 mm. More preferably, reusable silicone wraps in accordance with various aspects of the disclosure have thicknesses ranging from about 0.02 mm to about 1.5 mm. Even more preferably, reusable silicone wraps in accordance with various aspects of the disclosure have thicknesses ranging from about 0.02 mm to about 1.0 mm. In some instances, reusable silicone wraps in accordance with various aspects of the disclosure have thicknesses ranging from about 0.05 mm to about 1.0 mm. In some instances, reusable silicone wraps in accordance with various aspects of the disclosure have thicknesses ranging from about 0.1 mm to about 1.0 mm. In some instances, reusable silicone wraps in accordance with various aspects of the disclosure have thicknesses ranging from about 0.15 mm to about 1.0 mm. In some instances, reusable silicone wraps in accordance with various aspects of the disclosure have thicknesses ranging from about 0.2 mm to about 1.0 mm. In some instances, reusable silicone wraps in accordance with various aspects of the disclosure have thicknesses ranging from about 0.25 mm to about 1.0 mm. In some instances, reusable silicone wraps in accordance with various aspects of the disclosure have thicknesses ranging from about 0.3 mm to about 1.0 mm. In some instances, reusable silicone wraps in accordance with various aspects of the disclosure have thicknesses ranging from about 0.35 mm to about 1.0 mm. In some instances, reusable silicone wraps in accordance with various aspects of the disclosure have thicknesses ranging from about 0.4 mm to about 1.0 mm. In some instances, reusable silicone wraps in accordance with various aspects of the disclosure have thicknesses ranging from about 0.45 mm to about 1.0 mm. In some instances, reusable silicone wraps in accordance with various aspects of the disclosure have thicknesses ranging from about 0.5 mm to about 1.0 mm. In some instances, reusable silicone wraps in accordance with various aspects of the disclosure have thicknesses ranging from about 0.02 mm to about 0.95 mm. In some instances, reusable silicone wraps in accordance with various aspects of the disclosure have thicknesses ranging from about 0.02 mm to about 0.9 mm. In some instances, reusable silicone wraps in accordance with various aspects of the disclosure have thicknesses ranging from about 0.02 mm to about 0.85 mm. In some instances, reusable silicone wraps in accordance with various aspects of the disclosure have thicknesses ranging from about 0.02 mm to about 0.8 mm. In some instances, reusable silicone wraps in accordance with various aspects of the disclosure have thicknesses ranging from about 0.02 mm to about 0.75 mm. In some instances, reusable silicone wraps in accordance with various aspects of the disclosure have thicknesses ranging from about 0.02 mm to about 0.7 mm. In some instances, reusable silicone wraps in accordance with various aspects of the disclosure have thicknesses ranging from about 0.02 mm to about 0.65 mm. In some instances, reusable silicone wraps in accordance with various aspects of the disclosure have thicknesses ranging from about 0.02 mm to about 0.6 mm. In some instances, reusable silicone wraps in accordance with various aspects of the disclosure have thicknesses ranging from about 0.02 mm to about 0.55 mm. In some instances, reusable silicone wraps in accordance with various aspects of the disclosure have thicknesses ranging from about 0.02 mm to about 0.5 mm.

Reusable silicone wraps in accordance with various aspects of the disclosure exhibit elastomeric properties and can be made from a liquid silicone rubber (LSR) or composition comprising an LSR. As used in the disclosure, a “liquid silicone rubber” of “LSR” is defined as a two-component system (Components A and B) where long polysiloxane chains are reinforced with specially treated silica. Generally, Component A contains a platinum catalyst and Component B is a siloxane-containing composition. In some cases, Component A contains a platinum catalyst and Component B contains methylhydrogensiloxane as a cross-linker and an alcohol inhibitor. Components A and B are generally present in the two-component system in a 1:1 weight ratio. Components A and B are mixed and rapidly heat-cured during a molding process to form the reusable silicone wrap. LSRs are generally viscous, but pumpable, materials.

In some instances, the LSR used to make reusable silicone wraps can be modified to include one or more fillers. Suitable fillers include, but are not limited to, metal oxide particles such as, for example, silicon dioxide, titanium dioxide, zinc oxide and iron oxides. In some instances, the LSR used to make reusable silicone wraps can be modified to include an antimicrobial agent. In some instances, the LSR used to make reusable silicone wraps can be modified to include a biodegradable agent. In some instances, the LSR used to make reusable silicone wraps can be modified to include an anti-yellowing agent. In some instances, the LSR used to make reusable silicone wraps can be modified to include an anti-static agent. In some instances, the LSR used to make reusable silicone wraps can be an LSR composition having an LSR and two or more additives selected from fillers, antimicrobial agents, biodegradable agents, anti-yellowing agents, and anti-static agents. When one or more additives are added to the LSR, the resulting composition can be made of about 0.2 wt % to about 3 wt % of the one or more additives and about 97 wt % to about 99.8 wt % of the LSR. In some instances, when more than one additive is used, each additive can be present in the resulting composition in an amount ranging from about 0.2 wt % to about 3 wt %, alternatively from about 0.2 wt % to about 2.5 wt %, alternatively from about 0.2 wt % to about 2 wt %, alternatively from about 0.2 wt % to about 1.5 wt %, alternatively from about 0.2 wt % to about 1 wt %, alternatively from about 0.2 wt % to about 0.75 wt %, and alternatively from about 0.2 wt % to about 0.5 wt %.

In some instances, reusable silicone wraps according to various aspects of the disclosure can be transparent. In some instances, reusable silicone wraps according to various aspects of the disclosure can be translucent. In some instances, reusable silicone wraps according to various aspects of the disclosure can be completely opaque. In some instances, one or more colorants may be added to the LSR to provide reusable silicone wraps prepared therefrom, which may otherwise be transparent, translucent or opaque, with a desired color.

Reusable silicone wraps in accordance with various aspects of the disclosure can be made from any suitable food grade LSR that results in a reusable silicone wrap with a shore A hardness value ranging from about 20 to about 70. Preferably, an LSR that results in a reusable silicone wrap with a shore A hardness value ranging from about 20 to about 60 is used. More preferably, an LSR that results in a reusable silicone wrap with a shore A hardness value ranging from about 20 to about 50 is used. Even more preferably, an LSR that results in a reusable silicone wrap with a shore A hardness value ranging from about 20 to about 40 is used. Even more preferably, an LSR that results in a reusable silicone wrap with a shore A hardness value ranging from about 30 to about 40 is used. Exemplary Liquid Silicone Rubbers (LSRs) and the shore A hardness values of reusable silicone wraps made therefrom are provided below in Tables 1 and 2.

TABLE 1

| Shore A Hardness | 20 | 30 | 40 |
|---|---|---|---|
| ELASTOSIL ® LSRs | eco LR 5040/20 A/B | eco LR 5040/30 A/B | eco LR 5040/40 A/B |
| (Wacker Chemie AG) | (shore A = 20 ± 3) | (shore A = 31 ± 3) | (shore A = 40 ± 3) |
| | LR 3003/20 TR A/B | LR 3003/30 R A/B | LR 3003/40 A/B |
| | (shore A = 21 ± 3) | (shore A = 31 ± 3) | (shore A = 41 ± 3) |
| | LR 5040/20 A/B | LR 5040/30 A/B | LR 5040/40 A/B |
| | (shore A = 20 ± 3) | (shore A = 31 ± 3) | (shore A = 40 ± 3) |
| | | LR 3004/30 A/B | LR 3004/40 A/B |
| | | (shore A = 31 ± 3) | (shore A = 41 ± 3) |
| | | LR 3040/30 A/B | LR 3040/40 A/B |
| | | (shore A = 31 ± 3) | (shore A = 41 ± 3) |
| | | LR 3066/30 A/B | LR 3066/40 A/B |
| | | LR 3071/30 A/B | LR 3071/40 A/B |
| | | LR 3003/30 A/B | LR 3071/40 F A/B |
| | | LR 3671/30 A/B | LR 3671/40 A/B |
| | | | LR 3043/40 A/B |
| | | | LR 3271/45 A/B |
| | | | (shore A = 45) |
| | | | LR 5040/45 A/B |
| | | | (shore A = 45 ± 3) |
| SILPURAN ® LSRs | 6000/20 A/B | 6000/30 A/B | 6000/40 A/B |
| (Wacker Chemie AG) | | | 6400/40 A/B |
| | | | 6600/40 A/B |
| | | | 6610/40 A/B |
| | | | 6700/40 A/B |
| | | | 6740/40 A/B |
| SILASTIC ™LSRs | RBL-9200-20 | RBL-9200-30 | RBL-9200-40 |
| (Dow Chemical Co.) | | | |

TABLE 2

| Shore A Hardness | 50 | 60 | 70 |
|---|---|---|---|
| ELASTOSIL ® LSRs | eco LR 5040/50 A/B | eco LR 5040/60 A/B | eco LR 5040/70 A/B |
| (Wacker Chemie AG) | (shore A = 50 ± 3) | (shore A = 60 ± 3) | (shore A = 70 ± 3) |
| | LR 3003/50 A/B | LR 3003/60 A/B | LR 3003/60 A/B |
| | (shore A = 50 ± 3) | (shore A = 60 ± 3) | (shore A = 70 ± 3) |
| | LR 3004/50 A/B | LR 3004/60 A/B | LR 3004/70 A/B |
| | (shore A = 50 ± 3) | (shore A = 60 ± 3) | (shore A = 70 ± 3) |
| | LR 3040/50 A/B | LR 3040/60 A/B | LR 3040/70 A/B |
| | (shore A = 50 ± 3) | (shore A = 60 ± 3) | (shore A = 70 ± 3) |
| | LR 5040/50 A/B | LR 5040/60 A/B | LR 5040/70 A/B |
| | (shore A = 50 ± 3) | (shore A = 60 ± 3) | (shore A = 70 ± 3) |
| | LR 3066/50 A/B | LR 3066/60 A/B | LR 3066/70 A/B |
| | LR 3043/50 A/B | LR 3043/60 A/B | LR 3043/70 A/B |
| | LR 3071/50 A/B | LR 3071/60 A/B | |
| | LR 3071/50 F A/B | LR 3020/60 A/B | |
| | LR 3671/50 A/B | | |
| SILPURAN ® LSRs | 6000/50 A/B | 6000/60 A/B | 6000/70 A/B |
| (Wacker Chemie AG) | 6400/50 A/B | 6400/60 A/B | |
| | 6600/50 A/B | 6600/60 A/B | |
| | 6610/50 A/B | 6610/60 A/B | |
| | 6700/50 A/B | | |
| | 6760/50 A/B | | |
| SILASTIC ™ LSRs | RBL-9200-50 | RBL-9200-60 | RBL-9200-70 |
| (Dow Chemical Co.) | | | |

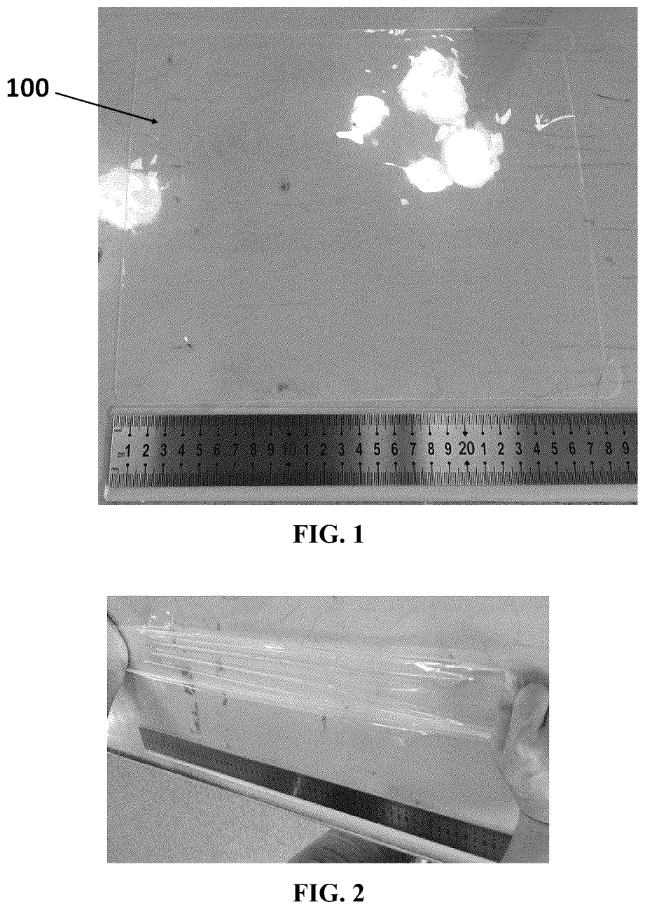

FIG. 1 is an image of a reusable silicone wrap 100 prepared in accordance with various aspects of the disclosure. The reusable silicone wrap 100 is substantially square in shape with a length (and width) of about 285 millimeters (mm), and is substantially transparent. Reusable silicone wrap 100 has a shore A hardness value of 40. FIG. 2 is an image showing reusable silicone wrap 100 in a fully stretched or extended state by manual hand pulling, as would be done by a user of the reusable silicone wrap 100. In the fully stretched or extended state, reusable silicone wrap 100 measures about 650 mm in length.

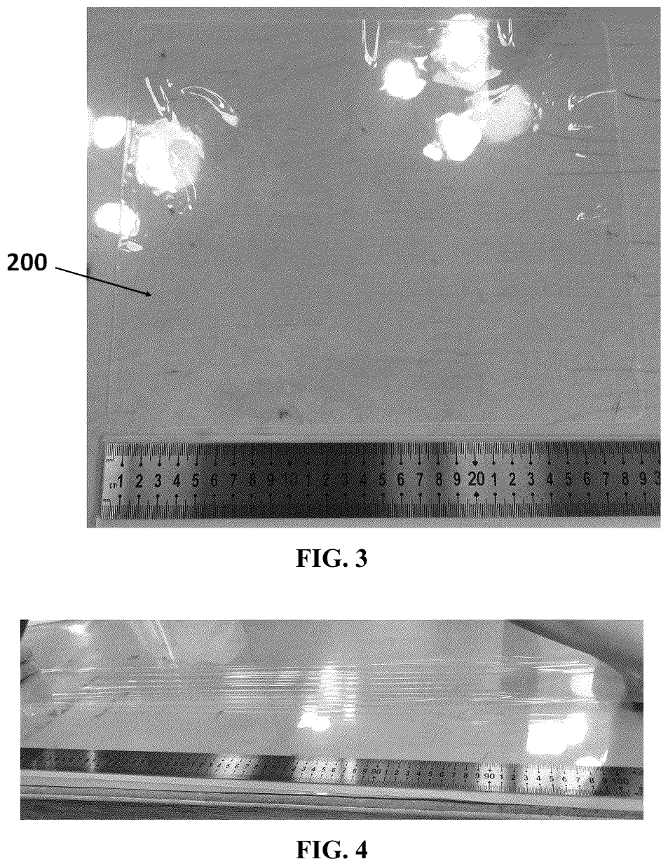

FIG. 3 is an image of a reusable silicone wrap 200 prepared in accordance with various aspects of the disclosure. The reusable silicone wrap 200 is substantially square in shape with a length (and width) of about 292 mm, and is substantially transparent. Reusable silicone wrap 200 has a shore A hardness value of 30. FIG. 4 is an image showing reusable silicone wrap 200 in a fully stretched or extended state by manual hand pulling, as would be done by a user of the reusable silicone wrap 100. In the fully stretched or extended state, reusable silicone wrap 200 measures about 1050 mm in length.

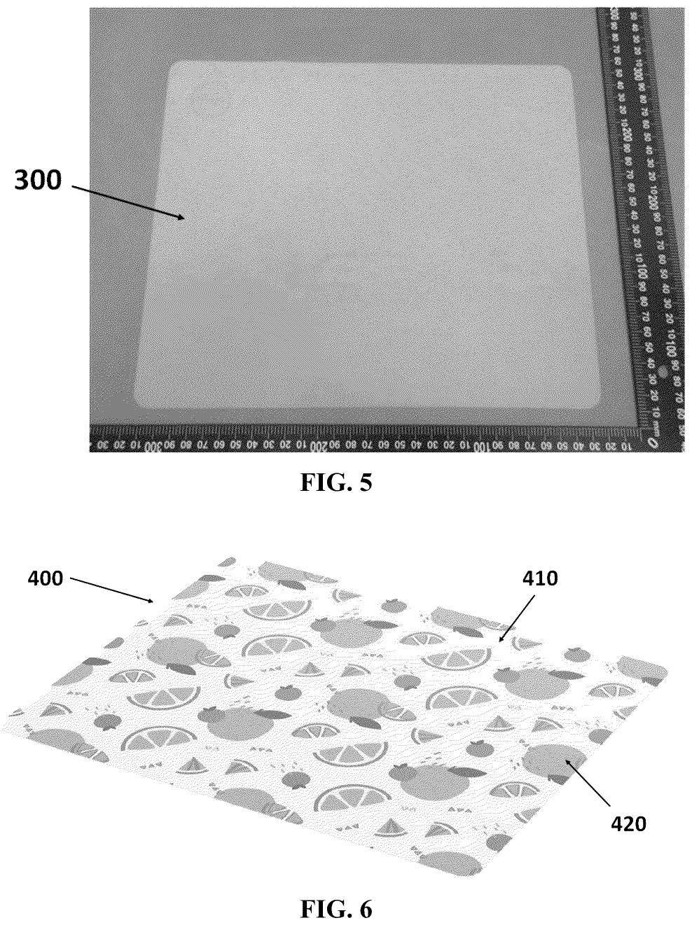

FIG. 5 is an image of a reusable silicone wrap 300 prepared in accordance with various aspects of the disclosure. The reusable silicone wrap 300 is substantially rectangular in shape with a length of about 290 mm and a width of about 244 mm, and is substantially opaque and white.

Reusable silicone wraps according to various aspects of the disclosure can be described as being in the form of a shaped sheet and two primary surfaces. A first surface can be described as a foodstuff-facing surface. When used on an individual foodstuff, the reusable silicone wrap can wrap around the individual foodstuff (such as, for example, a fruit, a vegetable, a tuber, a cooked or raw meat, a baked or sugar confection, and so on) and engage one or more surfaces of the foodstuff and/or itself to form an air-tight seal around the foodstuff. When used on kitchenware, the first surface would engage one or more surfaces (such an outer rim, sidewall(s), bottom surface(s), and so on) of a piece of kitchenware to form an air-tight seal between the reusable silicone wrap and the kitchenware, sealing the foodstuff therein. A second surface, opposite the first surface, can be described as an environment-facing surface. In some instances, the first surface and the second surface are interchangeable such that both surfaces may serve as a foodstuff-facing surface and an environment-facing surface.

In some instances, the first surface can be regularly or irregularly microtextured to provide the first surface with enhanced grip to a foodstuff and/or piece of kitchenware. In some instances, the second surface can be regularly or irregularly microtextured to provide the first surface with enhanced grip to a foodstuff and/or piece of kitchenware. In some instances, both the first surface and the second surface can be regularly or irregularly microtextured to provide the first surface with enhanced grip to a foodstuff and/or piece of kitchenware. The regular or irregular microtexture of the first and/or second surfaces can be achieved by using a mold to fabricate the reusable silicone wrap, where the mold has a regularly or irregularly microtextured surface.

In some instances, the first surface can be regularly or irregularly microtextured and the second surface can have an aesthetic layer applied thereto. The aesthetic layer can contain a colorant and/or graphics such as, for example an image, an illustration, or a pattern. The aesthetic layer can be applied and immobilized on the second surface using any suitable technique. In some instances, the aesthetic layer is applied as an adhesive composition such as a paint. In some instances, the aesthetic layer is a polymeric film having a shore A hardness value equal to or substantially equal to the reusable silicone wrap. Generally, when reusable silicone wraps according to various aspects of the disclosure include an aesthetic layer on the second surface, the first surface will be the foodstuff-facing surface and the second surface will be the environment-facing surface.

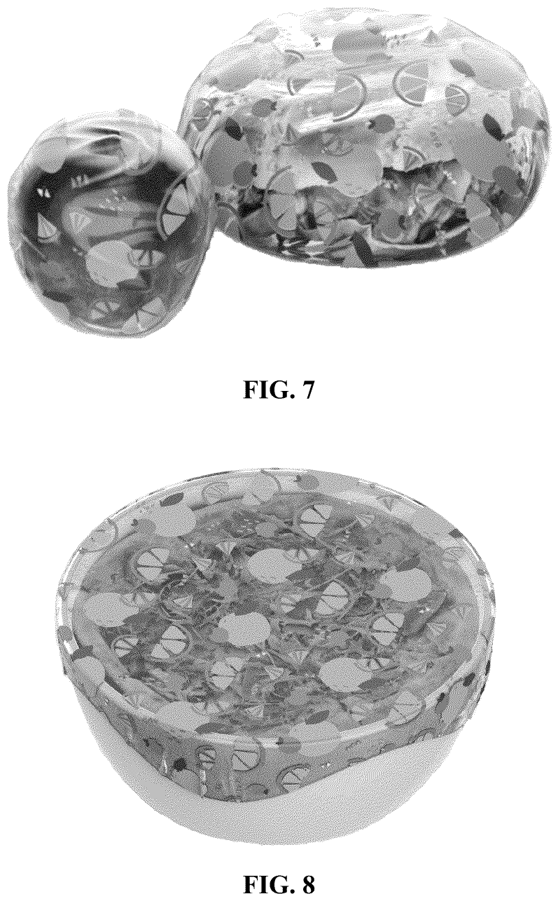

FIG. 6 is an image of an exemplary reusable silicone wrap 400 in accordance with various aspects of the disclosure. The reusable silicone wrap 400 includes a first, foodstuff-facing, surface (not shown) and a second, environment-facing, surface 410 located opposite the first surface. An aesthetic layer 420, is located on the second surface 420. FIG. 7 illustrates a use of the reusable silicone wrap 400 to encase foodstuffs, specifically an apple and a sandwich. FIG. 7 illustrates a use of the reusable silicone wrap 400, where a foodstuff-facing surface thereof is engaged with the outer rim and external sidewalls of a bowl to form an air-tight seal between the reusable silicone wrap and the bowl, sealing a foodstuff therein.

Reusable silicone wraps according to various aspects of the disclosure can be prepared from LSRs or LSR compositions by any suitable method such as, for example, injection molding, compression molding, calendering, or coating. In some instances, injection molding methodologies may be preferred. In some instances, compression molding methodologies may be preferred.

In some instances, reusable silicone wraps in accordance with various aspects of the disclosure can be made via injection molding processes from LSRs or LSR compositions. In order for a liquid injection molding process to fully occur, several mechanical components should be in place. Typically, an injection molding machine requires a metered pumping device in conjunction with an injection unit and an attached dynamic or static mixing unit. The critical components of a liquid injection molding machine include injectors, metering units, supply drums, mixers, a nozzle, and a mold clamp or mold press. Injectors are used to pressurize liquid silicone rubbers to aid in the injection of the LSR into the pumping section of the injection molding machine. Metering units pump liquid materials such, as the LSR and optional additives, at controlled amounts. Supply containers are connected to the main pumping system and serve as the primary containers for mixing materials. In some instances, one or more containers holding, for example, colorants, antimicrobial agents, biodegradable agents, anti-yellowing agents and/or anti-static agents can also be connected to the main pumping system. The static or dynamic mixer combines materials after they exit the metering units. Once combined, pressure is used to drive the mixture into a mold made of two mold plates. The two mold plates, when combined, form one or more cavities therein, within which reusable silicone wraps are formed from the LSR or LSR composition. The nozzle facilitates the deposition of the LSR or LSR composition into the mold. In some instances, the nozzle may include an automatic shut-off valve to help prevent leaking and/or overfilling of the mold. The mold clamp or mold press secures the mold during the injection molding process, and opens the mold upon completion.

An injection molding process for the fabrication of a reusable silicone wrap can proceed according to the following steps. Although specific steps of preparing a reusable silicone wrap using an injection molding process are described, in some instances, methods according to the disclosure may have more or less steps than the described steps without departing from the scope of the disclosure. In a first step, a silicone starting material is prepared. In some instances, preparing the silicone starting material can include mixing the LSR. In some instances, preparing the silicone starting material can include mixing one or more colorants with the LSR to provide the final reusable silicone wrap with a desired uniform color. In some instances, preparing the silicone starting material can include mixing the LSR with one or more of an antimicrobial agent, a biodegradable agent, an anti-yellowing agent and an anti-static agent. In some instances, preparing the silicone starting material can include mixing the LSR with with one or more colorants and/or one or more of an antimicrobial agent, a biodegradable agent, an anti-yellowing agent and an anti-static agent.

In a second step, the prepared silicone starting material is injected under an applied pressure into an injection mold, filling the cavity or cavities of the injection mold within which the reusable silicone wrap(s) are to be formed.

In a third step, the silicone starting material cured to form an intermediate of the final reusable silicone wrap. The intermediate comprises the final reusable silicone wrap and any excess silicone.

In a fourth step, the intermediate of the final reusable silicone wrap is removed from the injection mold and excess silicone, if any, is removed. Excess silicone can be removed by, for example, trimming or stamping.

In an optional fifth step, the final reusable silicone wrap is thermally treated to volatilize and remove any remaining organic materials.

One of ordinary skill in the art will readily appreciate that various parameters of the injection molding process (such as, injection pressure and temperature, curing time and time, and optional thermal treatment) may be varied in accordance with the properties of the silicone starting material (i.e., LSR or LSR composition) and the dimensions (lateral and/or thickness) of the reusable silicone wrap to be formed.

A compression molding process for the fabrication of a reusable silicone wrap can proceed according to the following steps. Although specific steps of preparing a reusable silicone wrap using a compression molding process are described, in some instances, methods according to the disclosure may have more or less steps than the described steps without departing from the scope of the disclosure. In a first step, a silicone starting material is prepared. In some instances, preparing the silicone starting material can include mixing the LSR. In some instances, preparing the silicone starting material can include mixing one or more colorants with the LSR to provide the final reusable silicone wrap with a desired uniform color. In some instances, preparing the silicone starting material can include mixing the LSR with one or more of an antimicrobial agent, a biodegradable agent, an anti-yellowing agent and an anti-static agent. In some instances, preparing the silicone starting material can include mixing the LSR with one or more colorants and/or one or more of an antimicrobial agent, a biodegradable agent, an anti-yellowing agent and an anti-static agent.

In a second step, a predetermined amount of the prepared silicone starting material is placed into the cavity or cavities of a compression mold within which the reusable silicone wraps are to be formed.

In a third step, the compression mold is subjected to heat and pressure to cure the silicone starting material and to form an intermediate of the final reusable silicone wrap. The intermediate comprises the final reusable silicone wrap and any excess silicone.

In a fourth step, the intermediate of the final reusable silicone wrap is removed from the compression mold and excess silicone, if any, is removed. Excess silicone can be removed by, for example, trimming or stamping.

In an optional fifth step, the final reusable silicone wrap is thermally treated to volatilize and remove any remaining organic materials.

One of ordinary skill in the art will readily appreciate that various parameters of the compression molding process (such as, compression pressure, temperature and time, and optional thermal treatment) may be varied in accordance with the properties of the silicone starting material (i.e., LSR or LSR composition) and the dimensions (lateral and/or thickness) of the reusable silicone wrap to be formed.

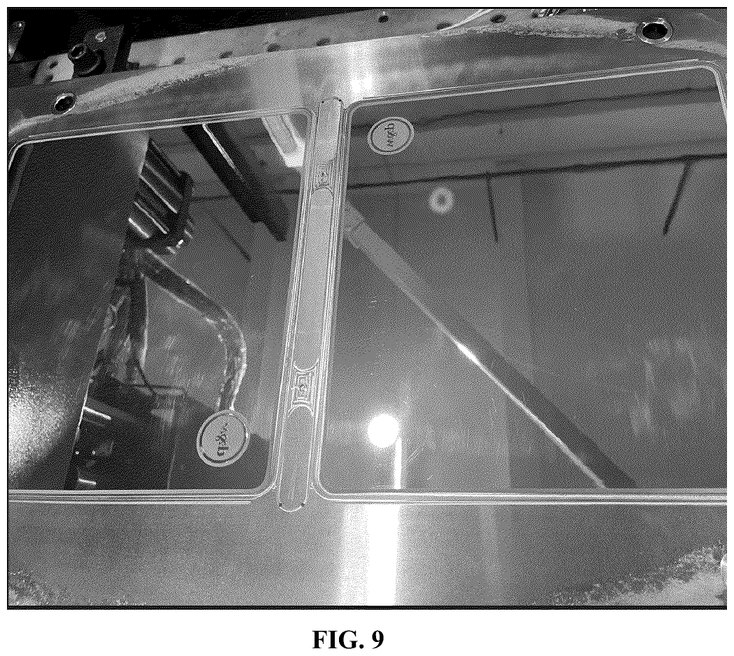

FIG. 9 is a partial image of an exemplary injection or compression mold plate used to make a reusable silicone wrap according to various aspects of the disclosure. As shown, the mold plate includes two mold sections for the preparation of two reusable silicone wraps. In use, an injection mold or a compression mold would have two mold plates, a top mold plate and a bottom mold plate that are mirror images of each other such that, when they are combined, the corresponding mirror image mold sections of each plate combine to form a corresponding cavity for the formation of a reusable silicone wrap therein. The mold plate of FIG. 9 has two mold sections that are substantially rectangular in shape. In some instances, mold plates according to the disclosure may have more or less mold sections, such as 1 or 3 to 10. In some instances, the mold sections are in a shape other than substantially rectangular, such as a square, circle, oval, hexagon, octagon and so on.

Advantageously, the mold sections of injection molds or compression molds according to various aspects of the disclosure have a roughened surface. The surface of the mold sections preferably have a surface roughness value (Ra) ranging from about 0.01 to about 0.5 μm, more preferably an Ra value ranging from about 0.01 to about 0.4 μm, even more preferably an Ra value ranging from about 0.01 to about 0.3 μm, even more preferably an Ra value ranging from about 0.01 to about 0.2 μm, and even more preferably an Ra value ranging from about 0.01 to about 0.1 μm. During molding, portions of the silicone starting material may conform to the peaks and valleys of a roughened mold section surface to result in a reusable silicone wrap that has a corresponding microtextured surface.

Although the invention and its objects, features and advantages have been described in detail, other embodiments are encompassed by the invention. All references cited herein are incorporate by reference in their entireties. Finally, those skilled in the art should appreciate that they can readily use the disclosed conception and specific embodiments as a basis for designing or modifying other structures for carrying out the same purposes of the invention without departing from the scope of the invention as defined by the appended claims.

1. A reusable silicone wrap, the wrap having a shore A hardness value ranging from about 20 to about 70 and a thickness ranging from about 0.02 mm to about 1.0 mm.

2. The reusable silicone wrap of claim 1, wherein the shore A hardness value ranges from about 20 to about 60.

3-5. (canceled)

6. The reusable silicone wrap of claim 1, wherein the shore A hardness value ranges from about 30 to about 40.

7. The reusable silicone wrap of claim 1, wherein the thickness ranges from about 0.5 mm to about 1.0 mm.

8. The reusable silicone wrap of claim 1, wherein the thickness ranges from about 0.02 mm to about 0.5 mm.

9. (canceled)

10. The reusable silicone wrap of claim 1, wherein the wrap is dimensioned to wrap around a foodstuff to form an air-tight seal around the foodstuff.

11. The reusable silicone wrap of claim 1, wherein the wrap is dimensioned to engage one or more surfaces of a piece of kitchenware to form an air-tight seal between the reusable silicone wrap and the piece of kitchenware.

12. (canceled)

13. The reusable silicone wrap of claim 1, wherein the wrap is made from a liquid silicone rubber (LSR) composition.

14. The reusable silicone wrap of claim 13, wherein the LSR composition comprises a liquid silicone rubber and one or more additives.

15. The reusable silicone wrap of claim 14, wherein the one or more additives are selected from the group consisting of fillers, antimicrobial agents, biodegradable agents, anti-yellowing agents, and anti-static agents.

16. The reusable silicone wrap of claim 14, wherein the LSR composition comprises from about 97 wt % to about 99.8 wt % of a liquid silicone rubber and from about 0.2 wt % to about 3.0 wt % of the one or more additives.

17. The reusable silicone wrap of claim 14, wherein the LSR composition comprises from about 0.2 wt % to about 3.0 wt % of fillers, antimicrobial agents, biodegradable agents, anti-yellowing agents and/or anti-static agents.

18-21. (canceled)

22. The reusable silicone wrap of claim 1, wherein the wrap comprises a foodstuff-facing surface and an environment facing surface.

23. The reusable silicone wrap of claim 22, wherein the foodstuff-facing surface is microtextured surface.

24. The reusable silicone wrap of claim 22, wherein the environment-facing surface is microtextured surface.

25. The reusable silicone wrap of claim 22, wherein the foodstuff-facing surface is microtextured and the environment-facing surface is microtextured.

26. The reusable silicone wrap of claim 22, further comprising an aesthetic layer immobilized on the environment-facing surface.

27. The reusable silicone wrap of claim 26, wherein the aesthetic layer comprises a colorant or graphics.

28. The reusable silicone wrap of claim 1, wherein the wrap is produced by any one of an injection molding process, a compression molding process, a calendering process, or a coating process.

29-30. (canceled)
